(19) United States
(12) Patent Application Publication
(10) Pub. No.: US 2026/0135687 A1
(43) Pub. Date: May 14, 2026

(54) SEGMENTED PRE-COMPENSATION SCHEMES FOR TIME DIVISION DUPLEXING IN A NON-TERRESTRIAL NETWORK

(71) Applicant: QUALCOMM Incorporated, San Diego, CA (US)

(72) Inventors: Ayan SENGUPTA, Mountain View, CA (US); Alberto RICO ALVARINO, San Diego, CA (US)

(21) Appl. No.: 19/380,638

(22) Filed: Nov. 5, 2025

Related U.S. Application Data
(60) Provisional application No. 63/718,487, filed on Nov. 8, 2024.

(51) Int. Cl. H04L 5/14; H04L 5/00; H04W 74/0833; H04W 84/06

(52) U.S. Cl. CPC H04L 5/1469; H04L 5/0044; H04W 74/0833; H04W 84/06

(57) ABSTRACT

Methods, systems, and devices for wireless communication are described. Various aspects generally relate to segmented pre-compensation schemes that account for time division duplexing (TDD) patterns involving periodic valid uplink subframes. Some aspects more specifically relate to a segmented pre-compensation scheme according to which a user equipment (UE) may reset a segment duration in a next valid uplink subframe in accordance with an interruption, by an invalid uplink subframe associated with a TDD pattern, of a segment within a prior valid uplink subframe. The UE may perform a time or frequency adjustment at or prior to the segment duration reset in the next valid uplink subframe. For example, if a first segment is interrupted by an invalid uplink subframe, the UE may transmit a postponed portion of the uplink message within a next valid uplink subframe in accordance with a new time or frequency adjustment.

### CROSS REFERENCES

The present Application for Patent claims benefit of U.S. Provisional Patent Application No. 63/718,487 by SENGUPTA et al., entitled “SEGMENTED PRE-COMPENSATION SCHEMES FOR TIME DIVISION DUPLEXING IN A NON-TERRESTRIAL NETWORK,” filed Nov. 8, 2024, assigned to the assignee hereof, and expressly incorporated by reference herein.

### TECHNICAL FIELD

The following relates to wireless communication, including segmented pre-compensation schemes for time division duplexing in a non-terrestrial network (NTN).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems may include or support non-terrestrial networks (NTNs). An NTN may be a network involving communication between two or more devices with at least one of the devices being a non-terrestrial device, such as a satellite. For example, an NTN may be a network that combines satellites, drones, high-altitude platforms, and/or (ground) base stations to extend cellular connectivity for UEs across various geographic locations.

### SUMMARY

The systems, methods, and devices of this disclosure each have several innovative aspects, no single one of which is solely responsible for the desirable attributes disclosed herein.

A method for wireless communication by a user equipment (UE) is described. The method may include receiving information indicative of a time division duplexing pattern associated with non-terrestrial network communication between the UE and a network entity, where the time division duplexing pattern is based on a periodicity of valid uplink subframes associated with the non-terrestrial network communication between the UE and the network entity and transmitting, within one or more valid uplink subframes in accordance with the periodicity of the valid uplink subframes, an uplink message in accordance with a segmented pre-compensation scheme that is based on the time division duplexing pattern.

A UE for wireless communication is described. The UE may include one or more memories storing processor executable code, and one or more processors coupled with (e.g., operatively, communicatively, functionally, electronically, or electrically) the one or more memories. The one or more processors may individually or collectively be operable to execute the code (e.g., directly, indirectly, after pre-processing, without pre-processing) to cause the UE to receive information indicative of a time division duplexing pattern associated with non-terrestrial network communication between the UE and a network entity, where the time division duplexing pattern is based on a periodicity of valid uplink subframes associated with the non-terrestrial network communication between the UE and the network entity and transmit, within one or more valid uplink subframes in accordance with the periodicity of the valid uplink subframes, an uplink message in accordance with a segmented pre-compensation scheme that is based on the time division duplexing pattern.

Another UE for wireless communication is described. The UE may include means for receiving information indicative of a time division duplexing pattern associated with non-terrestrial network communication between the UE and a network entity, where the time division duplexing pattern is based on a periodicity of valid uplink subframes associated with the non-terrestrial network communication between the UE and the network entity and means for transmitting, within one or more valid uplink subframes in accordance with the periodicity of the valid uplink subframes, an uplink message in accordance with a segmented pre-compensation scheme that is based on the time division duplexing pattern.

A non-transitory computer-readable medium storing code for wireless communication is described. The code may include instructions executable by one or more processors (e.g., directly, indirectly, after pre-processing, without pre-processing) to receive information indicative of a time division duplexing pattern associated with non-terrestrial network communication between the UE and a network entity, where the time division duplexing pattern is based on a periodicity of valid uplink subframes associated with the non-terrestrial network communication between the UE and the network entity and transmit, within one or more valid uplink subframes in accordance with the periodicity of the valid uplink subframes, an uplink message in accordance with a segmented pre-compensation scheme that is based on the time division duplexing pattern.

In some examples of the method, UEs, and non-transitory computer-readable medium described herein, the segmented pre-compensation scheme may be associated with a segment duration according to which the UE segments the uplink message in time and performs a respective time or frequency adjustment prior to each segment of the uplink message. In some examples of the method, UEs, and non-transitory computer-readable medium described herein, the segmented pre-compensation scheme defines that the segment duration may be reset in a next valid uplink subframe in accordance with an interruption, by an invalid uplink subframe associated with the time division duplexing pattern, of a segment within a prior valid uplink subframe.

In some examples of the method, UEs, and non-transitory computer-readable medium described herein, transmitting the uplink message in accordance with the segmented pre-compensation scheme may include operations, features, means, or instructions for transmitting a first portion of the uplink message within a first valid uplink subframe in accordance with a first time or frequency adjustment, where the first time or frequency adjustment may be associated with a first segment of the uplink message that includes the first portion of the uplink message, and transmitting a second portion of the uplink message within a second valid uplink subframe in accordance with a second time or frequency adjustment, where the second time or frequency adjustment may be associated with a second segment of the uplink message that includes the second portion of the uplink message, and where the second segment may be based on resetting the segment duration in accordance with an interruption of the first segment by one or more invalid uplink subframes between the first valid uplink subframe and the second valid uplink subframe.

Some examples of the method, UEs, and non-transitory computer-readable medium described herein may further include operations, features, means, or instructions for performing the first time or frequency adjustment at a beginning of the first segment of the uplink message in accordance with starting the segment duration, where a duration of the first segment may be defined by the segment duration, resetting the segment duration at a beginning of the second valid uplink subframe in accordance with the interruption of the first segment by the one or more invalid uplink subframes between the first valid uplink subframe and the second valid uplink subframe, and performing the second time or frequency adjustment at or prior to a beginning of the second segment of the uplink message in accordance with resetting the segment duration.

Some examples of the method, UEs, and non-transitory computer-readable medium described herein may further include operations, features, means, or instructions for transmitting or receiving an indication of a time gap within which the UE may be capable of performing a time or frequency adjustment associated with the segmented pre-compensation scheme, where the UE performs the first time or frequency adjustment and the second time or frequency adjustment within respective durations of time defined by the time gap. In some examples of the method, UEs, and non-transitory computer-readable medium described herein, for the first time or frequency adjustment, the UE counts the time gap as being within the first segment of the uplink message and, for the second time or frequency adjustment, the UE counts the time gap as being within the one or more invalid uplink subframes between the first valid uplink subframe and the second valid uplink subframe.

In some examples of the method, UEs, and non-transitory computer-readable medium described herein, for the second time or frequency adjustment, the UE counts the time gap as being within the one or more invalid uplink subframes between the first valid uplink subframe and the second valid uplink subframe in accordance with a duration of the one or more invalid uplink subframes being greater than or equal to the time gap.

In some examples of the method, UEs, and non-transitory computer-readable medium described herein, the second segment of the uplink message may have a same duration as other segments of the uplink message and the same duration may be defined by the segment duration.

In some examples of the method, UEs, and non-transitory computer-readable medium described herein, the second segment of the uplink message may have a different duration than other segments of the uplink message and a first duration of the other segments of the uplink message may be defined by the segment duration and the different duration of the second segment of the uplink message may be defined by a difference between the segment duration and a duration of the first segment of the uplink message within the first valid uplink subframe prior to the interruption.

In some examples of the method, UEs, and non-transitory computer-readable medium described herein, the uplink message includes a physical uplink shared channel (PUSCH) transmission, the first portion of the uplink message includes a first portion of the PUSCH transmission, and the second portion of the uplink message includes a second portion of the PUSCH transmission.

In some examples of the method, UEs, and non-transitory computer-readable medium described herein, the uplink message includes a physical random access channel (PRACH) transmission that includes a preamble repetition unit, the preamble repetition unit may be associated with a set of multiple symbol groups, the first portion of the uplink message includes a first one or more symbol groups of the set of multiple symbol groups, and the second portion of the uplink message includes a second one or more symbol groups of the set of multiple symbol groups.

In some examples of the method, UEs, and non-transitory computer-readable medium described herein, the segmented pre-compensation scheme may be based on the time division duplexing pattern in accordance with the periodicity of the valid uplink subframes satisfying a threshold periodicity.

In some examples of the method, UEs, and non-transitory computer-readable medium described herein, the time division duplexing pattern includes a set of multiple non-consecutive sets of valid uplink subframes and a set of multiple invalid uplink subframes and a quantity of invalid uplink subframes after each set of valid uplink subframe of the set of multiple non-consecutive sets of valid uplink subframes may be based on the periodicity of the valid uplink subframes.

In some examples of the method, UEs, and non-transitory computer-readable medium described herein, each set of valid uplink subframes of the set of multiple non-consecutive sets of valid uplink subframes includes one or more valid uplink subframes.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports segmented pre-compensation schemes for time division duplexing in a non-terrestrial network (NTN) in accordance with one or more aspects of the present disclosure.

FIG. 2 shows an example of a time division duplexing (TDD) pattern that supports segmented pre-compensation schemes for time division duplexing in an NTN in accordance with one or more aspects of the present disclosure.

FIG. 3 shows an example of a signaling diagram that supports segmented pre-compensation schemes for time division duplexing in an NTN in accordance with one or more aspects of the present disclosure.

FIG. 4 shows an example of a segmented pre-compensation scheme that supports segmented pre-compensation schemes for time division duplexing in an NTN in accordance with one or more aspects of the present disclosure.

FIG. 5 shows an example of a process flow that supports segmented pre-compensation schemes for time division duplexing in an NTN in accordance with one or more aspects of the present disclosure.

FIGS. 6 and 7 show block diagrams of devices that support segmented pre-compensation schemes for time division duplexing in an NTN in accordance with one or more aspects of the present disclosure.

FIG. 8 shows a block diagram of a communications manager that supports segmented pre-compensation schemes for time division duplexing in an NTN in accordance with one or more aspects of the present disclosure.

FIG. 9 shows a diagram of a system including a device that supports segmented pre-compensation schemes for time division duplexing in an NTN in accordance with one or more aspects of the present disclosure.

FIGS. 10 and 11 show flowcharts illustrating methods that support segmented pre-compensation schemes for time division duplexing in an NTN in accordance with one or more aspects of the present disclosure.

### DETAILED DESCRIPTION

Some wireless communications systems may include or support non-terrestrial networks (NTNs). An NTN may be a network involving communication between two or more devices with at least one of the devices being a non-terrestrial device, such as a satellite. For example, an NTN may be a network that combines satellites, drones, high-altitude platforms, and/or (ground) base stations to extend cellular connectivity for user equipments (UEs) across various geographic locations. In such examples, a UE communicating over or via an NTN may include a UE communicating (e.g., transmitting and/or receiving) with a satellite in orbit. Some NTNs may support a time division duplexing (TDD) pattern according to which a subset of subframes are valid in a configured, repetitive pattern. For example, some NTNs may support a TDD pattern according to which k out of every N subframes are valid uplink subframes, with k being any numeric quantity and N indicating (e.g., defining) a periodicity of (sets of) valid uplink subframes. The UE may transmit uplink messaging via valid uplink subframes and may refrain from transmitting uplink messaging via invalid uplink subframes (uplink subframes that are not valid uplink subframes) in accordance with the TDD pattern. Additionally, some UEs communicating over or via an NTN may perform a segmented pre-compensation scheme as part of transmitting an uplink message. Such UEs may include, for example, narrowband (NB) Internet of Things (IoT) UEs. In accordance with a segmented pre-compensation scheme, a UE may segment an uplink message and perform a time or frequency adjustment prior to one or more segments (e.g., each segment) of the uplink message, such as to maintain synchronization with an NTN entity (e.g., a satellite) throughout a transmission duration.

In scenarios in which the UE communicates in accordance with a TDD pattern that specifies a periodicity of valid uplink subframes (e.g., with k out of N subframes being valid uplink subframes) and performs segmented pre-compensation, the UE may experience situations in which segmented pre-compensation rules would result in poor performance for the UE or other UEs. Such situations may include, for example, a segment of an uplink message being interrupted by an invalid uplink subframe. In such scenarios, some segmented pre-compensation rules may specify that the UE is to postpone the remainder of the interrupted segment to a next valid uplink subframe and transmit within the remainder of the segment (in the next valid uplink subframe) without performing a time or frequency adjustment until a next segment starts. In other words, some segmented pre-compensation rules may specify that the UE strictly performs time or frequency adjustments at a beginning of a segment, without consideration of a TDD pattern (and, more specifically, without consideration of situations in which a segment is interrupted by an invalid uplink subframe defined by the TDD pattern). Such rules may result in inadequate time or frequency adjustments by the UE, which may lead to poor reliability and/or interference to other devices, especially in systems in which N is relatively large (e.g., for TDD patterns with relatively long gaps between valid uplink subframes). Thus, some systems may benefit from additional, or alternative, segmented pre-compensation rules associated with segment interruptions caused by invalid uplink subframes.

Various aspects generally relate to segmented pre-compensation schemes that account for TDD patterns involving periodic valid uplink subframes. Some aspects more specifically relate to a segmented pre-compensation scheme according to which a UE may reset a segment duration in a next valid uplink subframe in accordance with an interruption, by an invalid uplink subframe associated with a TDD pattern, of a segment within a prior valid uplink subframe. According to such aspects, the UE may perform a (fresh) time or frequency adjustment prior to transmitting a postponed portion of an uplink message in the next valid uplink subframe. For example, the UE may transmit a first portion of an uplink message within a first valid uplink subframe in accordance with a first time or frequency adjustment performed at a beginning of a first segment that includes the first portion of the uplink message. In examples in which the first segment is interrupted by one or more invalid uplink subframes between the first valid uplink subframe and a second (next) valid uplink subframe, the UE may transmit a second (postponed) portion of the uplink message within the second valid uplink subframe in accordance with a second time or frequency adjustment. The UE may perform the second time or frequency adjustment at or prior to a beginning of a second segment that includes the second portion of the uplink message, which the UE may start at (approximately) the same time that the second valid uplink subframe starts.

In some examples, the UE may perform a time or frequency adjustment within a duration of time defined by a time gap, which may be a signaled value associated with a capability of the UE. In such examples, the UE may count the time gap in a manner that is based on the TDD pattern. For example, for the first time or frequency adjustment, the UE may count the time gap as being within the first segment of the uplink message and, for the second time or frequency adjustment, the UE may count the time gap as being within the one or more invalid uplink subframes between the first valid uplink subframe and the second valid uplink subframe. In other words, in accordance with the second segment being triggered by a resetting of a segment duration in accordance with a segment interruption due to an invalid uplink subframe, the UE may (proactively) perform the second time or frequency adjustment corresponding to the second segment within the invalid uplink subframe(s) prior and likewise count the time gap as being within the invalid uplink subframe(s).

Particular aspects of the subject matter described herein may be implemented to realize one or more of the following advantages. For example, by resetting a segment duration in accordance with a segment interruption due to an invalid uplink subframe, the UE may maintain greater time/frequency synchronization with a network entity (e.g., a satellite in an NTN) while supporting various TDD patterns, including TDD patterns with relatively low duty-cycles (e.g., TDD patterns with relatively infrequent valid uplink subframes). Such greater time/frequency synchronization with the network entity may provide greater communication reliability between the UE and the network entity and may cause less interference to other devices within the system. Further, by counting a time gap associated with a time or frequency adjustment as being within one or more invalid uplink subframes prior to resetting a segment duration in accordance with a segment interruption due to the one or more invalid uplink subframes, the UE may avoid puncturing uplink data within the second segment. In accordance with avoiding a puncturing of uplink data within the second segment, the UE may achieve or facilitate greater throughput, which may support higher data rates, greater system capacity, and greater spectral efficiency, among other benefits. Moreover, by supporting reliable and higher capacity communication over or via an NTN with segmented pre-compensation that is able to accommodate various TDD patterns, the described techniques may support enhanced coexistence across various devices, systems, networks, technologies, and protocols.

Aspects of the disclosure are initially described in the context of wireless communications systems. Additionally, aspects of the disclosure are further illustrated by and described with reference to a TDD pattern, a signaling diagram, a segmented pre-compensation scheme, and a process flow. Aspects of the disclosure are further illustrated by and described with reference to apparatus diagrams, system diagrams, and flowcharts that relate to segmented pre-compensation schemes for time division duplexing in a non-terrestrial network.

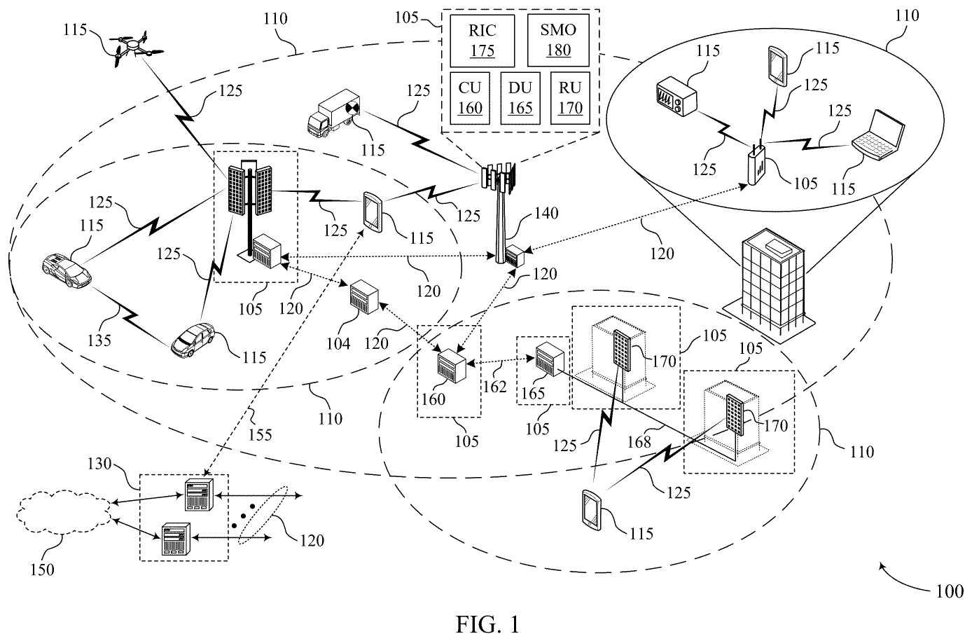

FIG. 1 shows an example of a wireless communications system 100 that supports segmented pre-compensation schemes for time division duplexing in a non-terrestrial network in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein. Components within a wireless communication system may be coupled (for example, operatively, communicatively, functionally, electronically, and/or electrically) to each other.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, or computing system may include disclosure of the UE 115, network entity 105, apparatus, device, or computing system being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support segmented pre-compensation schemes for time division duplexing in a non-terrestrial network as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an IoT device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In some aspects, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may include, support, or be an example of one or more NTNs. An NTN may be a network involving communication between two or more devices with at least one of the devices being a non-terrestrial device, such as a satellite. For example, an NTN may be a network that combines satellites, drones, high-altitude platforms, and/or (ground) base stations to extend cellular connectivity for UEs 115 across various geographic locations. In such examples, a UE 115 communicating over or via an NTN may include a UE 115 communicating with a satellite in orbit. Some NTNs may support a TDD pattern according to which a subset of subframes are valid in a configured, repetitive pattern. For example, some NTNs may support a TDD pattern according to which k out of every N subframes are valid uplink subframes, with k being any numeric quantity (e.g., 1, 2, or 3) and N indicating (e.g., defining) a periodicity of valid uplink subframes. The UE 115 may transmit uplink messaging via valid uplink subframes and may refrain from transmitting uplink messaging via invalid uplink subframes in accordance with the TDD pattern. The uplink messaging that the UE 115 may transmit may include physical uplink shared channel (PUSCH) transmissions and/or physical random access channel (PRACH) transmissions, among other examples. Further, in examples in which the UE 115 supports NB-IoT communication, such uplink messaging may be understood as NB PUSCH (NPUSCH) and/or NB PRACH (NPRACH), among other examples.

An NPRACH message/transmission may be associated with a transmission of a preamble within each of multiple symbol groups. In some aspects, an NPRACH transmission may be associated with a preamble repetition unit (PRU), which may define a transmission of a preamble within each of multiple symbol groups. For example, a PRU may be associated with multiple symbol groups (e.g., groups of one or more symbols) within which a UE 115 transmits a preamble via different or varying subcarriers. For example, a PRU may be associated with 4 symbol groups. In such examples, a UE 115 may transmit a preamble via a first subcarrier (or via a first set of subcarriers starting from a first subcarrier) within a first symbol group of the 4 symbol groups, may transmit the preamble via a second subcarrier (or via a second set of subcarriers starting from a second subcarrier) within a second symbol group of the 4 symbol groups, and so on. Thus, in accordance with using PRU-based NPRACH transmissions, a UE 115 may repeat a preamble across time and frequency (and, in some examples, across a defined or indicated pattern of time and/or frequency resources). An NPRACH transmission may include one PRU or multiple PRUs.

Some UEs 115 communicating over or via an NTN may perform a segmented pre-compensation scheme as part of transmitting an uplink message. Such UEs 115 may include, for example, NB-IoT UEs 115. In accordance with a segmented pre-compensation scheme, a UE 115 may segment an uplink message and perform a time or frequency adjustment prior to one or more segments (e.g., each segment) of the uplink message, such as to maintain synchronization with an NTN entity (e.g., a satellite) throughout a transmission duration. For example, a segmented pre-compensation scheme may be associated with a segment duration according to which the UE 115 segments the uplink message in time and performs a time or frequency adjustment prior to one or more segment of the uplink message. The segment duration may be defined by a parameter, such as a signaled parameter that the UE 115 may receive from a network entity 105. Such a parameter may be an NPUSCH-TxDuration-NB parameter, an NPRACH-TxDurationFmt01-NB parameter, or an NPRACH-TxDurationFmt2-NB parameter. The segment duration may be defined in units of milliseconds (for an NPUSCH transmission) or in units of a quantity of preamble repetition units (PRUs) (for an NPRACH transmission).

In some implementations, a UE 115 may support one or more segmented pre-compensation schemes that account for TDD patterns involving periodic valid uplink subframes. For example, the UE 115 may support a segmented pre-compensation scheme according to which the UE 115 resets a segment duration in a next valid uplink subframe in accordance with an interruption, by an invalid uplink subframe associated with a TDD pattern, of a segment within a prior valid uplink subframe. According to such aspects, the UE 115 may perform a (fresh) time or frequency adjustment prior to transmitting a postponed portion of an uplink message in the next valid uplink subframe. For example, the UE 115 may transmit a first portion of an uplink message within a first valid uplink subframe in accordance with a first time or frequency adjustment performed at a beginning of a first segment that includes the first portion of the uplink message. In examples in which the first segment is interrupted by one or more invalid uplink subframes between the first valid uplink subframe and a second (next) valid uplink subframe, the UE 115 may transmit a second (postponed) portion of the uplink message within the second valid uplink subframe in accordance with a second time or frequency adjustment. The UE 115 may perform the second time or frequency adjustment at or prior to a beginning of a second segment that includes the second portion of the uplink message, which the UE 115 may start at (approximately) the same time that the second valid uplink subframe starts.

In some examples, the UE 115 may perform a time or frequency adjustment within a duration of time defined by a time gap, which may be a signaled value associated with a capability of the UE 115. For example, the time gap may be defined by an ntn-SegmentedPrecompensationGaps parameter (which may have a value that is negotiated or coordinated between the UE 115 and a network entity 105). In such examples, the UE 115 may count the time gap in a manner that is based on the TDD pattern. For example, for the first time or frequency adjustment, the UE 115 may count the time gap as being within the first segment of the uplink message and, for the second time or frequency adjustment, the UE 115 may count the time gap as being within the one or more invalid uplink subframes between the first valid uplink subframe and the second valid uplink subframe. In other words, in accordance with the second segment being triggered by a resetting of a segment duration in accordance with a segment interruption due to an invalid uplink subframe, the UE 115 may (proactively) perform the second time or frequency adjustment corresponding to the second segment within the invalid uplink subframe(s) prior and likewise count the time gap as being within the invalid uplink subframe(s).

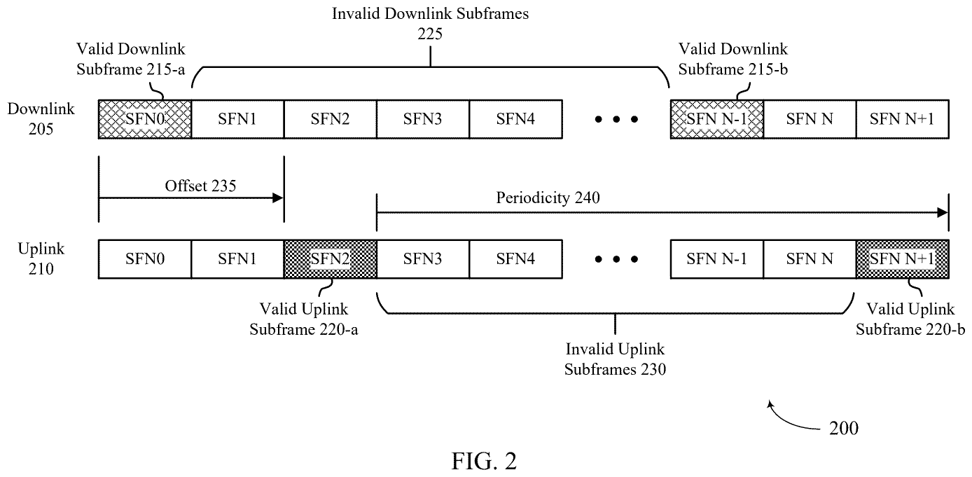

FIG. 2 shows an example of a TDD pattern 200 that supports segmented pre-compensation schemes for time division duplexing in an NTN in accordance with one or more aspects of the present disclosure. The TDD pattern 200 may be implemented in accordance with one or more aspects of the wireless communications system 100. For example, a UE 115 (e.g., an NB-IoT UE 115) may communicate over or via an NTN in accordance with the TDD pattern 200. In other words, the TDD pattern 200 may be associated with NTN communication between the UE 115 and a network entity 105 (e.g., a satellite) and may facilitate NB-IoT over an NTN. The TDD pattern 200 may be defined or configured by an operator (e.g., a network operator).

The TDD pattern 200 may include a downlink 205 associated with periodic valid downlink subframes and an uplink 210 associated with periodic valid uplink subframes. The downlink 205 may be associated with non-consecutive sets of valid downlink subframes including a valid downlink subframe 215-a and a valid downlink subframe 215-b. The valid downlink subframe 215-a and the valid downlink subframe 215-b may be associated with (e.g., used for) NTN communication from the network entity 105 to the UE 115. By way of further example, the uplink 210 may be associated with non-consecutive sets of valid uplink subframes including a valid uplink subframe 220-a and a valid uplink subframe 220-b. The valid uplink subframe 220-a and the valid uplink subframe 220-b may be associated with (e.g., used for) NTN communication from the UE 115 to the network entity 105.

A remainder of subframes associated with the downlink 205 and the uplink 210, outside of the valid subframes, may be understood as invalid subframes. For example, the downlink 205 may be associated with a set of invalid downlink subframes 225 between the valid downlink subframe 215-a and the valid downlink subframe 215-b. The UE 115 may not expect to receive NTN communication from the network entity 105 via an invalid downlink subframe. By way of further example, the uplink 210 may be associated with a set of invalid uplink subframes 230 between the valid uplink subframe 220-a and the valid uplink subframe 220-b. The UE 115 may refrain from transmitting NTN communication to the network entity 105 via an invalid uplink subframe.

In some aspects, the TDD pattern 200 may be associated with an offset 235 between the downlink 205 and the uplink 210. The offset 235, which may be understood as a downlink-uplink offset, may be an offset for downlink-uplink separation in time, such as a scheduling offset used in uplink-downlink timing relationships in NTN. In accordance with the offset 235, the TDD pattern 200 may be understood or referred to as half-duplex at the network level (because of the time domain separation between the downlink 205 and the uplink 210, which may be associated with different carriers or frequency bands in some implementations). For example, in accordance with the offset 235, one or more first radio subframes out of a set of (e.g., N) radio subframes may be used for uplink and one or more second radio subframes out of the set of radio subframes may be used for downlink, the one or more first radio subframes being non-overlapping with the one or more second radio subframes.

The TDD pattern 200 may further be associated with (or otherwise based on) a periodicity 240 of valid subframes. As illustrated in the example of the TDD pattern 200, the periodicity 240 may be of valid uplink subframes associated with the NTN communication between the UE 115 and the network entity 105. Additionally, or alternatively, the periodicity 240 may be of valid downlink subframes associated with the NTN communication between the UE 115 and the network entity 105. The periodicity 240 may be associated with (e.g., define) a duty-cycle of the TDD pattern 200. In examples in which the periodicity 240 satisfies a threshold (e.g., is greater than or equal to a threshold), the TDD pattern 200 may be an example of a low duty-cycle TDD mode of operation to facilitate NB-IoT over the NTN. Further, in accordance with the periodicity 240, the TDD pattern 200 may be associated with a k out of N approach to NTN communication, such that k (downlink or uplink) subframes are available (usable or valid) for NTN communication out of a set of N (downlink or uplink) subframes. k may be any numeric quantity, such as one, two, three, four, and so on. A set of k valid (downlink or uplink) subframes may occur in accordance with the periodicity 240. In some aspects, the UE 115 may receive an indication of N (e.g., the periodicity 240) via a signaled parameter, such as a selectiveAvailability-periodicity parameter.

Some systems, however, may lack mechanisms to support such a low duty-cycle mode of operation (e.g., in NB-IoT). For example, due to sparse and discontinuous availability of uplink and downlink resources, several aspects (e.g., mapping physical channels to time domain resources, applying transformations to physical channels, or validity durations for some timers) may be affected differently than in systems without such a low duty-cycle mode of operation. Some implementations of the present disclosure support one or more signaling- or configurational-based mechanisms according to which the UE 115 and/or the network entity 105 may support uplink time or frequency pre-compensation on account of a low duty-cycle TDD mode of operation.

For example, for communicating over NTNs, the UE 115 may perform time or frequency adjustments within uplink transmissions (e.g., within relatively long uplink transmissions, such as transmissions associated with NB-IoT) to mitigate against time or frequency drifts that may result due to a movement of the network entity 105 (e.g., a satellite) relative to the UE 115 throughout (e.g., during) the uplink transmission. To perform a time or frequency adjustment, the UE 115 may receive positional or ephemeris information from the network entity 105 (e.g., via one or more system information blocks (SIBs), among other example signaling), calculate a (predicted or estimated) time or frequency drift at a given time based on the positional or ephemeris information, and perform a time or frequency adjustment (at the time for which the drift was calculated) based on the calculated time or frequency drift.

In some systems, for a UE 115 (e.g., an NB-IoT UE 115) communicating over NTN, the UE 115 may adjust time or frequency pre-compensation per uplink segment. An uplink segment may be associated with a segment duration, which may be a transmission duration that defines how often (e.g., at what times throughout an uplink transmission) the UE 115 performs a time or frequency adjustment. The segment duration may be defined in one or more of various units of time and, in some aspects, may depend on whether the uplink transmission is a PUSCH (e.g., an NPUSCH) transmission or a PRACH (e.g., an NPRACH) transmission.

In examples in which the uplink transmission is a PUSCH or NPUSCH transmission, the segment duration may be defined by a transmission duration of

$${N}_{segment}^{pre - compensation}$$

time units. The quantity of

$${N}_{segment}^{pre - compensation}$$

may be received or obtained by the UE 115 via higher layers. For example,

$${N}_{segment}^{pre - compensation}$$

may be defined or indicated by an NPUSCH-TxDuration-NB parameter (e.g., an NPUSCH-TxDuration-NB-r17 parameter), which may be a sequence including an npusch-TxDuration parameter (e.g., an npusch-TxDuration-r17 parameter) indicating an enumerated value of {ms2, ms4, ms8, ms16, ms32, ms64, ms128, ms256}. “ms2” may be indicative of a segment duration of 2 milliseconds, “ms4” may be indicative of a segment duration of 4 milliseconds, and so on. By way of example, if “ms4” is indicated and if an uplink transmission is 10 milliseconds long, the UE 115 may perform a first time or frequency adjustment at the 5th millisecond of the uplink transmission and may perform a second time or frequency adjustment at the 9th millisecond of the uplink transmission.

In examples in which the uplink transmission is a PRACH or NPRACH transmission, the segment duration may be defined at a granularity of a PRU. In such examples, the UE 115 may receive an indication of a parameter indicative of the segment duration, with the parameter based on a format of a corresponding PRACH resource. For example, for a PRACH resource format 0 or format 1 in an NTN transmission, a duration of a PRACH segment transmission may be indicated by an NPRACH-TxDurationFmt01-NB parameter (e.g., an NPRACH-TxDurationFm101-NB-r17 parameter) that indicates a unit in duration of PRU. The NPRACH-TxDurationFmt01-NB parameter may be a sequence including an nprach-TxDurationFm101 parameter (e.g., an nprach-TxDurationFm101-r17 parameter) indicating an enumerated value of {n2, n4, n8, n16, n32, n64}. A value of “n2” may be indicative of a duration of 2 PRUs, a value of “n4” may be indicative of a duration of 4 PRUs, and so on. By way of further example, for a PRACH resource format 2 in an NTN transmission, a duration of a PRACH segment transmission may be indicated by an NPRACH-TxDurationFmt2-NB parameter (e.g., an NPRACH-TxDurationFmt2-NB-r17 parameter) that indicates a unit in duration of PRU. The NPRACH-TxDurationFmt2-NB parameter may be a sequence including an nprach-TxDurationFmt2 parameter (e.g., an nprach-TxDurationFmt2-r17 parameter) indicating an enumerated value of {n1, n2, n4, n8, n16}. A value of “n1” may be indicative of a duration of 1 PRU, a value of “n2” may be indicative of a duration of 2 PRUs, and so on.

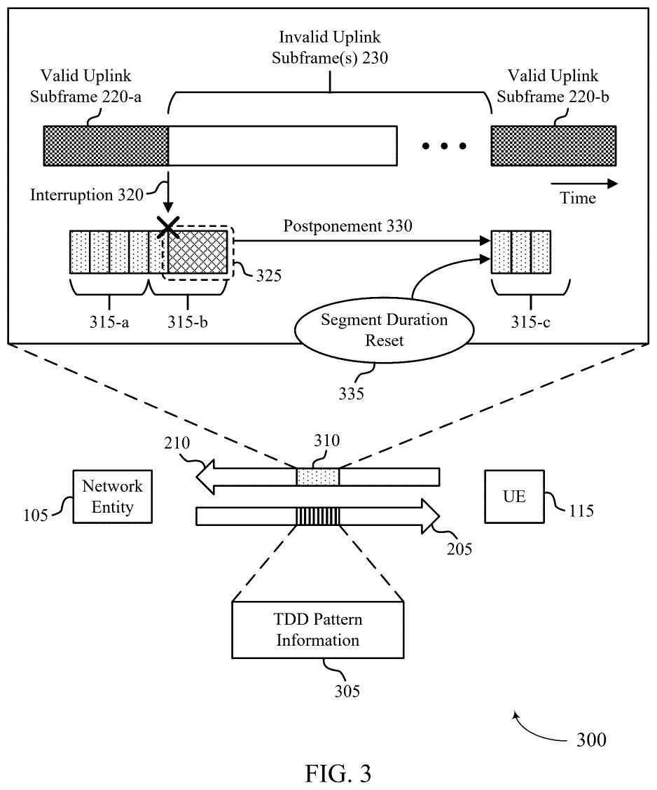

Due to the discontinuities in the valid uplink subframes (e.g., valid uplink occasions) associated with the TDD pattern 200, some segments of an uplink message (e.g., a PUSCH/NPUSCH message/transmission or a PRACH/NPRACH message/transmission) may overlap with an invalid uplink subframe (e.g., an invalid uplink occasion). In such situations, the UE 115 may postpone at least a portion of the uplink message to a next valid uplink subframe and implement a segmented pre-compensation scheme that is based on the TDD pattern 200 to continue to mitigate time or frequency drift across the uplink message (e.g., to appropriately maintain uplink synchronization). Additional details relating to such a segmented pre-compensation scheme that is based on the TDD pattern 200 are illustrated and described herein, including by and with reference to FIGS. 3-5.

FIG. 3 shows an example of a signaling diagram 300 that supports segmented pre-compensation schemes for time division duplexing in a non-terrestrial network in accordance with one or more aspects of the present disclosure. The signaling diagram 300 may implement or may be implemented to realize or facilitate one or more aspects of the wireless communications system 100 or the TDD pattern 200. For example, the signaling diagram 300 illustrates communication between a UE 115 and a network entity 105, which may be examples of corresponding devices as illustrated and described herein, including by and with reference to FIGS. 1 and 2. For example, the UE 115 and the network entity 105 may communicate via a downlink 205 and an uplink 210, such as in accordance with the TDD pattern 200.

In some aspects, the UE 115 may receive, from the network entity 105, information 305 indicative of the TDD pattern 200. Such information 305 may include or indicate the offset 235, the periodicity 240, or other parameters or information associated with the TDD pattern 200. For example, in accordance with the information 305, the UE 115 may identify respective locations of the valid uplink subframe 220-a, the valid uplink subframe 220-b, and a quantity of invalid uplink subframes 230 between the valid uplink subframe 220-a and the valid uplink subframe 220-b. The UE 115 may additionally receive information indicative of a segment duration (e.g., a quantity of milliseconds or a quantity of PRUs) associated with a segmented pre-compensation scheme.

The UE 115 may transmit an uplink message 310 in accordance with the TDD pattern 200. For example, the UE 115 may transmit the uplink message 310 within one or more valid uplink subframes (e.g., one or both of the valid uplink subframe 220-a or the valid uplink subframe 220-b) in accordance with the TDD pattern 200. Additionally, in accordance with a segmented pre-compensation scheme, the UE 115 may segment the uplink message 310 into a plurality of segments. For example, the UE 115 may segment the uplink message 310 into a segment 315-a and a segment 315-b. The UE 115 may transmit at least a portion of the uplink message 310 within the valid uplink subframe 220-a and, in some situations, the segment 315-b may be interrupted by an invalid uplink subframe. In accordance with such an interruption 320 of the segment 315-b by an invalid uplink subframe, the UE 115 may postpone at least a portion 325 of the uplink message 310 to a next valid uplink subframe, such as the valid uplink subframe 220-b. In some implementations, in accordance with such a postponement 330 of the portion 325 of the uplink message 310 because of the interruption 320 of the segment 315-b, the UE 115 may perform a segment duration reset 335 at the beginning of the valid uplink subframe 220-b to start a segment 315-c. The UE 115 may transmit the portion 325 of the uplink message 310 that was postponed within the segment 315-c.

In other words, if an uplink transmission segment for the uplink message 310 (e.g., an NPUSCH message or an NPRACH message) is interrupted (and therefore postponed) due to an invalid uplink occasion associated with the TDD pattern 200, the segment duration is reset from the start of the postponed transmission, in the next valid uplink occasion. In accordance with postponing the portion 325 of the uplink message 310 and performing the segment duration reset 335 at the start of the postponed transmission, the UE 115 may perform a time or frequency adjustment at or prior to the start of the postponed transmission (e.g., at or prior to the start of the valid uplink subframe 220-b).

In some implementations, the segment 315-c may have a same duration as other segments of the uplink message 310. Such a same duration may be defined by or otherwise associated with the indicated segment duration. For example, if the segment duration is 4 time units, a length of the segment 315-c may be 4 time units. In some other implementations, the segment 315-c may have a different duration than other segments of the uplink message 310. In such implementations, the other segments of the uplink message 310 (such as the segments not resulting from an interruption 320 by an invalid uplink subframe) may have a first duration defined by or otherwise associated with the indicated segment duration and the segment 315-c may have a different duration. Such a different duration may be defined by or otherwise associated with a difference between the indicated segment duration and a length of the segment 315-b before the interruption 320. For example, if the segment duration is 4 time units and a length of the segment 315-b within the valid uplink subframe 220-a before the interruption 320 is 1 time unit, a length of the segment 315-c may be 3 time units. A next segment subsequent to the segment 315-c may have a duration of 4 time units (in accordance with that next segment not resulting from an interruption 320 by an invalid uplink subframe).

In examples in which the uplink message 310 includes an NPRACH message or transmission, the UE 115 may postpone an entirety of an interrupted PRU to the segment 315-c in the valid uplink subframe 220-b to keep the symbol groups of the PRU consecutive in time. In such examples in which an entire interrupted PRU of the NPRACH is postponed to a next valid uplink subframe, the segment durations may follow baseline segmented pre-compensation rules after the UE 115 performs the segment duration reset 335 (e.g., after resetting the segment to the start of the postponement). In such examples, a length of the segment 315-c may be equal to a quantity of PRUs indicated by the segment duration.

Alternatively, and also in examples in which the uplink message 310 includes an NPRACH message or transmission, the UE 115 may postpone a subset of an interrupted PRU (e.g., a subset of symbol groups of the PRU) to the valid uplink subframe 220-b while transmitting a remainder of the PRU (e.g., a remainder of the symbol groups of the PRU) within the segment 315-b in the valid uplink subframe 220-a. In such examples in which a subset of the PRU is postponed (e.g., such that one or more interrupted symbol groups of an interrupted PRU are postponed but one or more symbol groups of the interrupted PRU prior to the interruption 320 are not postponed), the UE 115 may perform the segment duration reset 335 multiple times. For example, the UE 115 may perform a first segment duration reset 335 at a beginning of the postponed transmission (e.g., to cover the remaining symbol groups of the previous/interrupted PRU) and may perform a second segment duration reset 335 after the postponed symbol groups form the previous/interrupted PRU are transmitted. In other words, the UE 115 may perform the second segment duration reset 335 at a beginning of a next PRU after the interrupted PRU, which may enable the UE 115 to return back to a PRU level of granularity for subsequent segmentation after the interrupted PRU. In such examples, a length of the segment 315-c may be less than a quantity of PRUs indicated by the segment duration, with one or more segments subsequent to the segment 315-c returning to having lengths equal to the quantity of PRUs indicated by the segment duration.

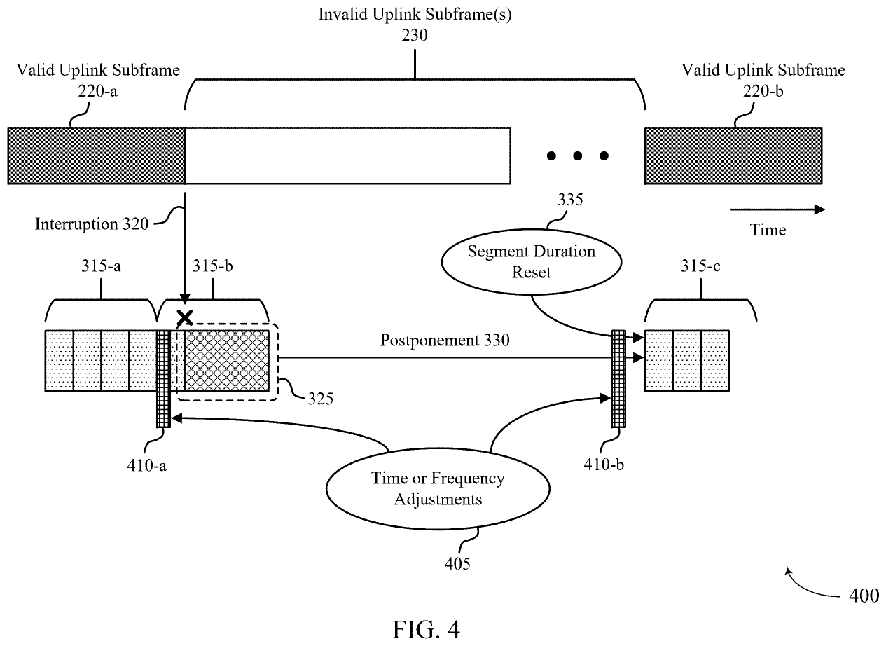

FIG. 4 shows an example of a segmented pre-compensation scheme 400 that supports segmented pre-compensation schemes for time division duplexing in a non-terrestrial network in accordance with one or more aspects of the present disclosure. The segmented pre-compensation scheme 400 may implement or be implemented to realize one or more aspects of the wireless communications system 100, the TDD pattern 200, or the signaling diagram 300. For example, a UE 115, which may be an example of corresponding devices as illustrated and described herein, may perform the segmented pre-compensation scheme 400 to maintain uplink synchronization across the interruption 320 of the segment 315-b by an invalid uplink subframe and a corresponding postponement 330 of at least the portion 325 of the uplink message 310 to the valid uplink subframe 220-b.

In some aspects, the UE 115 may use a time gap associated with segmented pre-compensation. In such aspects, the UE 115 may use the time gap to perform a time or frequency adjustment. For example, based on a capability of the UE 115, the UE 115 may use a time gap between successive segments to adjust time or frequency. The UE 115 may transmit or receive an indication of such a time gap, which may be indicated or defined by a parameter. Such a parameter may be an nin-SegmentedPrecompensationGaps parameter (e.g., an ntn-SegmentedPrecompensationGaps-r17 parameter) that indicates an enumerated value from {sym1, sl1, sl2}. The parameter may indicate a minimum or lower limit supported gap length between segments for segmented uplink transmission, with a value of “sym1” being indicative of a time gap of 1 symbol, a value of “sl1” being indicative of a time gap of 1 slot, and a value of “sl2” being indicative of a time gap of 2 slots. In examples in which the UE 115 communicates over an NTN, after transmissions (and/or postponements due to NPRACH) of a segment duration (e.g.

$${N}_{segment}^{pre - compensation}$$

time units), for at least some frame structure types (e.g., a frame structure type 1), the UE 115 (and/or the network entity 105) may count a transmission gap of

$${N}_{gap}^{pre - compensation}$$

time units for the (NPUSCH) resource mapping but not used for transmission (of the NPUSCH) according to the UE capability indicated by the nin-SegmentedPrecompensationGaps parameter. Thus, such a time gap may be equivalently referred to as a transmission gap of

$${N}_{gap}^{pre - compensation}$$

time units, as indicated by the ntn-SegmentedPrecompensationGaps parameter.

In accordance with the segmented pre-compensation scheme 400, the UE 115 may perform multiple time or frequency adjustments 405 including a first time or frequency adjustment 405 associated with the segment 315-b and a second time or frequency adjustment 405 associated with the segment 315-c. In some aspects, the UE 115 may perform the time or frequency adjustments 405 in accordance with or otherwise based on the TDD pattern 200. For example, the UE 115 may selectively or proactively perform a time or frequency adjustment 405 at a specific time in accordance with whether a segment corresponding to the time or frequency adjustment 405 is a result of a segment duration reset due to an uninterrupted expiration of a previous segment or is a result of a segment duration reset 335 due to an interruption 320 of a previous segment.

For example, because the segment 315-b is a result of an uninterrupted expiration of the segment 315-a, the UE 115 may perform the first time or frequency adjustment 405 within a first duration 410-a (having a length defined by the indicated time gap) within the segment 315-b (e.g., at a start of the segment 315-b). By way of further example, because the segment 315-c is a result of the interruption 320 of the segment 315-b, the UE 115 may perform the second time or frequency adjustment 405 within a second duration 410-b (having a length defined by the indicated time gap) within the set of invalid uplink subframes 230 between the valid uplink subframe 220-a and the valid uplink subframe 220-b. In other words, for an interrupted segment, when the transmission is postponed to a next valid TDD uplink transmission occasion, the UE 115 may perform a corresponding time or frequency adjustment within at least one invalid uplink subframe prior to the next valid TDD uplink transmission occasion. In such implementations, the UE 115 may count the duration first duration 410-a (e.g., the time gap that defines the length of the first duration 410-a) as being within the segment 315-b and may count the second duration 410-b (e.g., the time gap that defines the length of the second duration 410-b) as being within the set of invalid uplink subframes 230 between the valid uplink subframe 220-a and the valid uplink subframe 220-b.

The counting of the first duration 410-a (e.g., the time gap that defines the length of the first duration 410-a) within the segment 315-b may result in a puncturing of the segment 315-b, as the UE 115 may use some amount of time resources of the segment 315-b to perform the first time or frequency adjustment prior to transmitting within the segment 315-b. The counting of the second duration 410-b (e.g., the time gap that defines the length of the second duration 410-b) within the set of invalid uplink subframes 230 (e.g., within an invalid uplink duration) may increase throughput and data rates by avoiding a (potentially unnecessary) puncturing of the portion of the uplink message 310 transmitted within the segment 315-c (as the UE 115 may have sufficient time to perform the adjustment prior to the start of the segment 315-c without hindering uplink throughput).

The segment 315-c may be absent of puncturing in accordance with the performance of the second time or frequency adjustment 405 within the second duration 410-b prior to the segment 315-c. In some aspects, the UE 115 may schedule the second duration 410-b such that it occurs (approximately) immediately prior to the beginning of the segment 315-c, so as to reduce any time or frequency drift between the adjustment and when the UE 115 next transmits. By scheduling the second duration 410-b prior to the segment 315-c, the UE 115 may perform the second time or frequency adjustment 405 associated with the segment 315-c prior to the segment duration reset 335 that starts the segment 315-c. The UE 115 may perform the second time or frequency adjustment 405 within the set of invalid uplink subframes 230 between the valid uplink subframe 220-a and the valid uplink subframe 220-b in accordance with a duration of the set of invalid uplink subframes 230 being greater than the time gap.

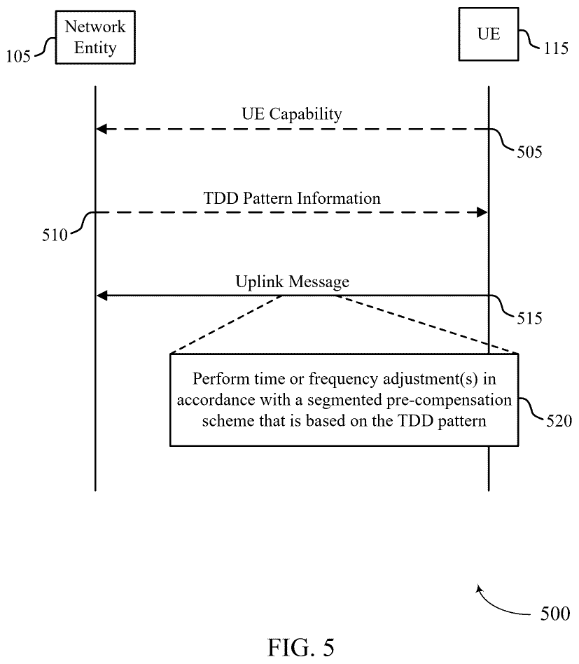

FIG. 5 shows an example of a process flow 500 that supports segmented pre-compensation schemes for time division duplexing in a non-terrestrial network in accordance with one or more aspects of the present disclosure. The process flow 500 may implement or be implemented to realize one or more aspects of the wireless communications system 100, the TDD pattern 200, the signaling diagram 300, or the segmented pre-compensation scheme 400. For example, the process flow 500 illustrates communication between a UE 115 and a network entity 105, which may be examples of corresponding devices as illustrated and described herein, including by or with reference to FIGS. 1-4.

In the following description of the process flow 500, the operations may be performed (e.g., reported or provided) in a different order than the order shown, or the operations performed by the example devices may be performed in different orders or at different times. Some operations also may be left out of the process flow 500, or other operations may be added to the process flow 500. Further, although some operations or signaling may be shown to occur at different times for discussion purposes, these operations may actually occur at the same time.

At 505, the UE 115 may transmit, to the network entity 105, information indicative of a capability of the UE 115. For example, the UE 115 may transmit an indication of a time gap within which the UE 115 may perform a time or frequency adjustment. Such a time gap may be defined or indicated by an nin-SegmentedPrecompensationGaps parameter. Additionally, or alternatively, the UE 115 may receive an indication of the time gap from the network entity 105. For example, the UE 115 and the network entity 105 may negotiate or coordinate, via unit-directional (e.g., from the UE 115 to the network entity 105) or bi-directional signaling (e.g., from the UE 115 to the network entity 105 and/or from the network entity 105 to the UE 115) on the time gap associated with the capability of the UE to perform a time or frequency adjustment. Additionally, or alternatively, the UE 115 may transmit an indication of whether the UE 115 supports a segmented pre-compensation scheme that is based on a TDD pattern, whether the UE 115 supports a TDD pattern with periodic valid uplink subframes, whether the UE 115 supports a low duty-cycle TDD pattern, or whether the UE 115 supports counting a time gap associated with performing a time or frequency adjustment prior to a start of an associated segment (e.g., within one or more invalid uplink subframes prior to the start of the associated segment), among other aspects described herein.

At 510, the UE 115 may receive, from the network entity 105, information (e.g., the information 305) indicative of a TDD pattern (e.g., the TDD pattern 200). The information may indicate any one or more parameters associated with the TDD pattern, such as a downlink-uplink offset, a periodicity associated with valid (downlink or uplink) subframes, or numeric value(s) of k or N in accordance with the TDD pattern being associated with a k out of N approach, among other aspects described herein. By way of example, k may be equal to any first numeric quantity (e.g., 1, 2, or 3, among other examples) and N may be equal to any second numeric quantity (e.g., 2, 5, or 10, among other examples). Each k valid uplink subframes may be referred to herein as a set of valid uplink subframes, with the TDD pattern being associated with multiple non-consecutive sets of valid uplink subframes (such that, for example, a first k valid uplink subframes are non-consecutive with a second k valid uplink subframes). Sets of valid uplink subframes may be non-consecutive by way of being separated by one or more invalid uplink subframes. A quantity of invalid uplink subframes between two sets of valid uplink subframes may be defined by or otherwise associated with N-k.

At 515, the UE 115 may transmit an uplink message within one or more valid uplink subframes (e.g., in accordance with the periodicity of the valid uplink subframes). The uplink message may be a PUSCH (e.g., an PUSCH) transmission or a PRACH (e.g., an PRACH) transmission, among other examples. In some implementations, as part of transmitting the uplink message, the UE 115 may, at 520, perform one or more time or frequency adjustments in accordance with a segmented pre-compensation scheme (e.g., the segmented pre-compensation scheme 400) that is based on the TDD pattern. A time or frequency adjustment may refer to a time domain adjustment, a frequency domain adjustment, or both. The segmented pre-compensation scheme may be associated with a segment duration according to which the UE 115 segments the uplink message (to perform time or frequency adjustments at intervals within the transmission of the uplink message). Additionally, in some examples, the segmented pre-compensation scheme may define that the segment duration is reset in a next valid uplink subframe in accordance with an interruption, by an invalid uplink subframe associated with the TDD pattern, of a segment within a prior valid uplink subframe.

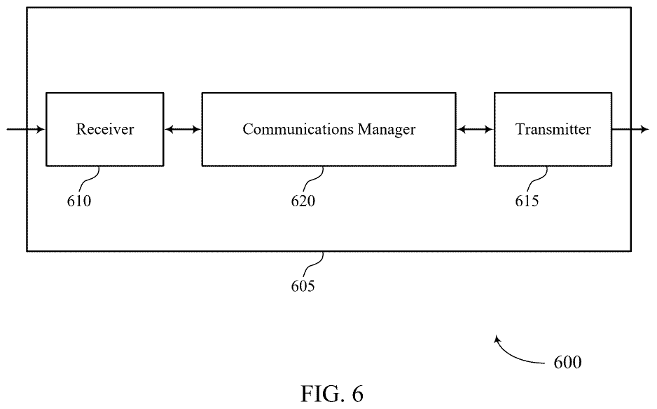

FIG. 6 shows a block diagram 600 of a device 605 that supports segmented pre-compensation schemes for time division duplexing in a non-terrestrial network in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to segmented pre-compensation schemes for time division duplexing in a non-terrestrial network). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to segmented pre-compensation schemes for time division duplexing in a non-terrestrial network). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of segmented pre-compensation schemes for time division duplexing in a non-terrestrial network as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a graphics processing unit (GPU), a central processing unit (CPU), a neural processing unit (NPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, a GPU, an NPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. For example, the communications manager 620 is capable of, configured to, or operable to support a means for receiving information indicative of a time division duplexing pattern associated with non-terrestrial network communication between the UE and a network entity, where the time division duplexing pattern is based on a periodicity of valid uplink subframes associated with the non-terrestrial network communication between the UE and the network entity. The communications manager 620 is capable of, configured to, or operable to support a means for transmitting, within one or more valid uplink subframes in accordance with the periodicity of the valid uplink subframes, an uplink message in accordance with a segmented pre-compensation scheme that is based on the time division duplexing pattern.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for greater time or frequency synchronization and more efficient utilization of communication resources, among other benefits.

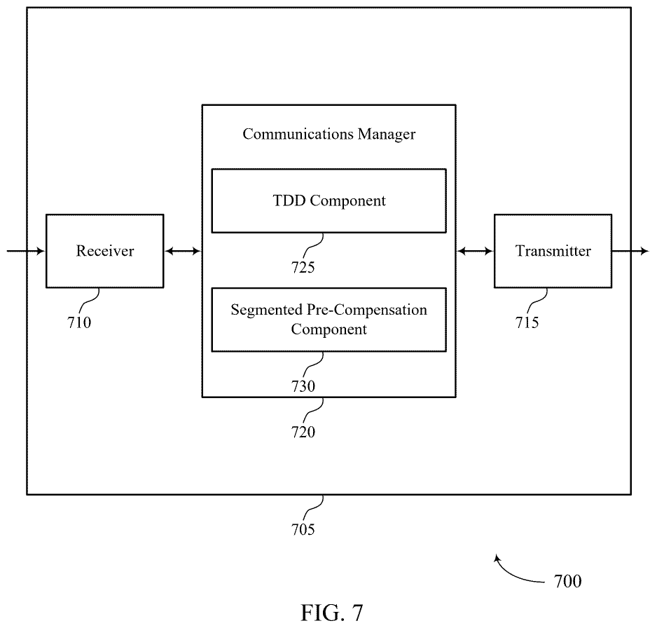

FIG. 7 shows a block diagram 700 of a device 705 that supports segmented pre-compensation schemes for time division duplexing in a non-terrestrial network in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to segmented pre-compensation schemes for time division duplexing in a non-terrestrial network). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to segmented pre-compensation schemes for time division duplexing in a non-terrestrial network). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of segmented pre-compensation schemes for time division duplexing in a non-terrestrial network as described herein. For example, the communications manager 720 may include a TDD component 725 a segmented pre-compensation component 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. The TDD component 725 is capable of, configured to, or operable to support a means for receiving information indicative of a time division duplexing pattern associated with non-terrestrial network communication between the UE and a network entity, where the time division duplexing pattern is based on a periodicity of valid uplink subframes associated with the non-terrestrial network communication between the UE and the network entity. The segmented pre-compensation component 730 is capable of, configured to, or operable to support a means for transmitting, within one or more valid uplink subframes in accordance with the periodicity of the valid uplink subframes, an uplink message in accordance with a segmented pre-compensation scheme that is based on the time division duplexing pattern.

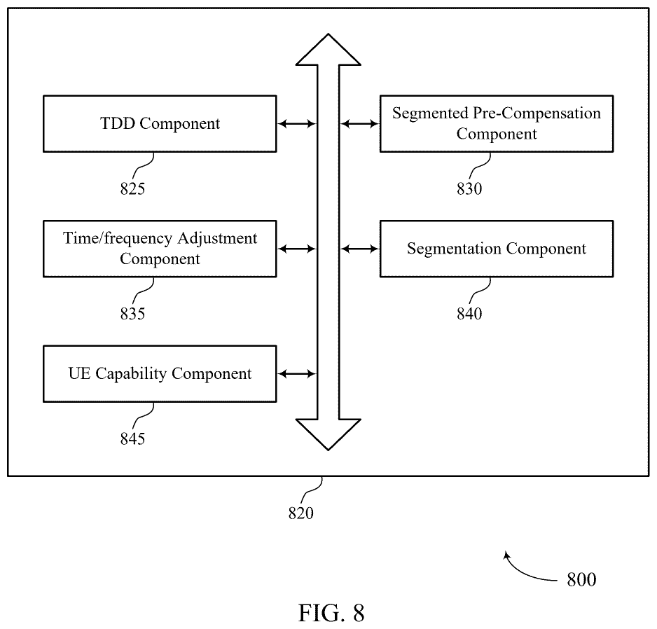

FIG. 8 shows a block diagram 800 of a communications manager 820 that supports segmented pre-compensation schemes for time division duplexing in a non-terrestrial network in accordance with one or more aspects of the present disclosure. The communications manager 820 may be an example of aspects of a communications manager 620, a communications manager 720, or both, as described herein. The communications manager 820, or various components thereof, may be an example of means for performing various aspects of segmented pre-compensation schemes for time division duplexing in a non-terrestrial network as described herein. For example, the communications manager 820 may include a TDD component 825, a segmented pre-compensation component 830, a time/frequency adjustment component 835, a segmentation component 840, a UE capability component 845, or any combination thereof. Each of these components, or components or subcomponents thereof (e.g., one or more processors, one or more memories), may communicate, directly or indirectly, with one another (e.g., via one or more buses).

The communications manager 820 may support wireless communication in accordance with examples as disclosed herein. The TDD component 825 is capable of, configured to, or operable to support a means for receiving information indicative of a time division duplexing pattern associated with non-terrestrial network communication between the UE and a network entity, where the time division duplexing pattern is based on a periodicity of valid uplink subframes associated with the non-terrestrial network communication between the UE and the network entity. The segmented pre-compensation component 830 is capable of, configured to, or operable to support a means for transmitting, within one or more valid uplink subframes in accordance with the periodicity of the valid uplink subframes, an uplink message in accordance with a segmented pre-compensation scheme that is based on the time division duplexing pattern.

In some examples, the segmented pre-compensation scheme is associated with a segment duration according to which the UE segments the uplink message in time and performs a respective time or frequency adjustment prior to each segment of the uplink message. In some examples, the segmented pre-compensation scheme defines that the segment duration is reset in a next valid uplink subframe in accordance with an interruption, by an invalid uplink subframe associated with the time division duplexing pattern, of a segment within a prior valid uplink subframe.

In some examples, to support transmitting the uplink message in accordance with the segmented pre-compensation scheme, the segmented pre-compensation component 830 is capable of, configured to, or operable to support a means for transmitting a first portion of the uplink message within a first valid uplink subframe in accordance with a first time or frequency adjustment, where the first time or frequency adjustment is associated with a first segment of the uplink message that includes the first portion of the uplink message. In some examples, to support transmitting the uplink message in accordance with the segmented pre-compensation scheme, the segmented pre-compensation component 830 is capable of, configured to, or operable to support a means for transmitting a second portion of the uplink message within a second valid uplink subframe in accordance with a second time or frequency adjustment, where the second time or frequency adjustment is associated with a second segment of the uplink message that includes the second portion of the uplink message, and where the second segment is based on resetting the segment duration in accordance with an interruption of the first segment by one or more invalid uplink subframes between the first valid uplink subframe and the second valid uplink subframe.

In some examples, the time/frequency adjustment component 835 is capable of, configured to, or operable to support a means for performing the first time or frequency adjustment at a beginning of the first segment of the uplink message in accordance with starting the segment duration, where a duration of the first segment is defined by the segment duration. In some examples, the segmentation component 840 is capable of, configured to, or operable to support a means for resetting the segment duration at a beginning of the second valid uplink subframe in accordance with the interruption of the first segment by the one or more invalid uplink subframes between the first valid uplink subframe and the second valid uplink subframe. In some examples, the time/frequency adjustment component 835 is capable of, configured to, or operable to support a means for performing the second time or frequency adjustment at or prior to a beginning of the second segment of the uplink message in accordance with resetting the segment duration.

In some examples, the UE capability component 845 is capable of, configured to, or operable to support a means for transmitting or receiving an indication of a time gap within which the UE is capable of performing a time or frequency adjustment associated with the segmented pre-compensation scheme, where the UE performs the first time or frequency adjustment and the second time or frequency adjustment within respective durations of time defined by the time gap. In some examples, for the first time or frequency adjustment, the UE counts the time gap as being within the first segment of the uplink message and, for the second time or frequency adjustment, the UE counts the time gap as being within the one or more invalid uplink subframes between the first valid uplink subframe and the second valid uplink subframe.

In some examples, for the second time or frequency adjustment, the UE counts the time gap as being within the one or more invalid uplink subframes between the first valid uplink subframe and the second valid uplink subframe in accordance with a duration of the one or more invalid uplink subframes being greater than or equal to the time gap.

In some examples, the second segment of the uplink message has a same duration as other segments of the uplink message. In some examples, the same duration is defined by the segment duration.

In some examples, the second segment of the uplink message has a different duration than other segments of the uplink message. In some examples, a first duration of the other segments of the uplink message is defined by the segment duration and the different duration of the second segment of the uplink message is defined by a difference between the segment duration and a duration of the first segment of the uplink message within the first valid uplink subframe prior to the interruption.

In some examples, the uplink message includes a PUSCH transmission. In some examples, the first portion of the uplink message includes a first portion of the PUSCH transmission. In some examples, the second portion of the uplink message includes a second portion of the PUSCH transmission.

In some examples, the uplink message includes a PRACH transmission that includes a preamble repetition unit. In some examples, the preamble repetition unit is associated with a set of multiple symbol groups. In some examples, the first portion of the uplink message includes a first one or more symbol groups of the set of multiple symbol groups. In some examples, the second portion of the uplink message includes a second one or more symbol groups of the set of multiple symbol groups.

In some examples, the segmented pre-compensation scheme is based on the time division duplexing pattern in accordance with the periodicity of the valid uplink subframes satisfying a threshold periodicity. In other words, the UE may selectively use the segmented pre-compensation scheme that is based on the time division duplexing pattern depending on the periodicity of the valid uplink subframes. If the periodicity satisfies (e.g., is greater than or equal to) the threshold periodicity, the UE 115 may use the segmented pre-compensation scheme that is based on the time division duplexing pattern. If the periodicity fails to satisfy (e.g., is less than) the threshold periodicity, the UE 115 may use another segmented pre-compensation scheme (e.g., a segmented pre-compensation scheme that is not based on the time division duplexing pattern).

In some examples, the time division duplexing pattern includes a set of multiple non-consecutive sets of valid uplink subframes and a set of multiple invalid uplink subframes. In some examples, a quantity of invalid uplink subframes after each set of valid uplink subframe of the set of multiple non-consecutive sets of valid uplink subframes is based on the periodicity of the valid uplink subframes. In some examples, each set of valid uplink subframes of the set of multiple non-consecutive sets of valid uplink subframes includes one or more valid uplink subframes.

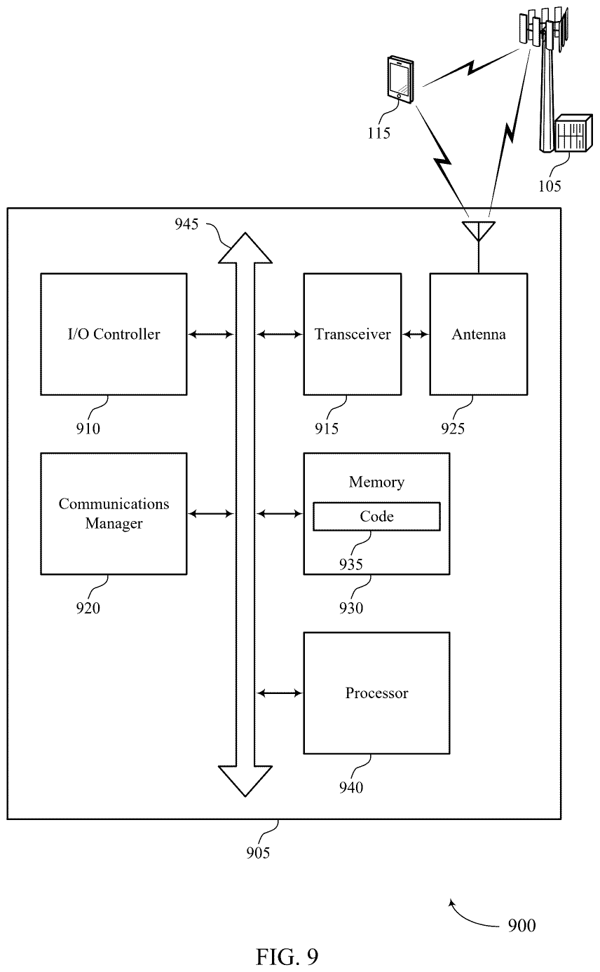

FIG. 9 shows a diagram of a system 900 including a device 905 that supports segmented pre-compensation schemes for time division duplexing in a non-terrestrial network in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more GPUs, one or more NPUs (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting segmented pre-compensation schemes for time division duplexing in a non-terrestrial network). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communication in accordance with examples as disclosed herein. For example, the communications manager 920 is capable of, configured to, or operable to support a means for receiving information indicative of a time division duplexing pattern associated with non-terrestrial network communication between the UE and a network entity, where the time division duplexing pattern is based on a periodicity of valid uplink subframes associated with the non-terrestrial network communication between the UE and the network entity. The communications manager 920 is capable of, configured to, or operable to support a means for transmitting, within one or more valid uplink subframes in accordance with the periodicity of the valid uplink subframes, an uplink message in accordance with a segmented pre-compensation scheme that is based on the time division duplexing pattern.

By including or configuring the communications manager 920 in accordance with examples as described herein, the device 905 may support techniques for improved communication reliability, reduced latency, more efficient utilization of communication resources, improved coordination between devices, longer battery life, and improved utilization of processing capability, among other benefits.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of segmented pre-compensation schemes for time division duplexing in a non-terrestrial network as described herein, or the at least one processor 940 and the at least one memory 930 may be otherwise configured to, individually or collectively, perform or support such operations.

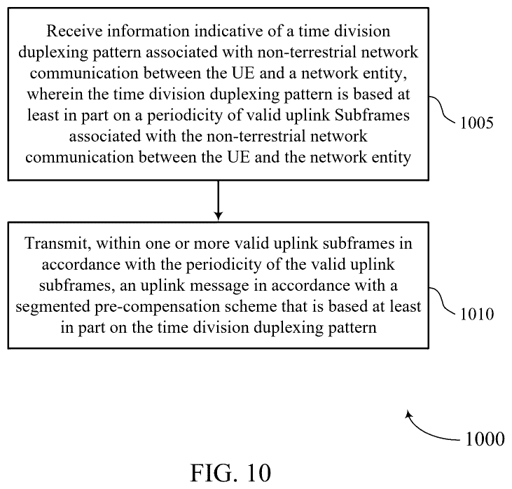

FIG. 10 shows a flowchart illustrating a method 1000 that supports segmented pre-compensation schemes for time division duplexing in a non-terrestrial network in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving information indicative of a time division duplexing pattern associated with non-terrestrial network communication between the UE and a network entity, wherein the time division duplexing pattern is based at least in part on a periodicity of valid uplink subframes associated with the non-terrestrial network communication between the UE and the network entity. The operations of 1005 may be performed in accordance with examples as disclosed herein. In some examples, aspects of the operations of 1005 may be performed by a TDD component 825 as described with reference to FIG. 8.

At 1010, the method may include transmitting, within one or more valid uplink subframes in accordance with the periodicity of the valid uplink subframes, an uplink message in accordance with a segmented pre-compensation scheme that is based at least in part on the time division duplexing pattern. The operations of 1010 may be performed in accordance with examples as disclosed herein. In some examples, aspects of the operations of 1010 may be performed by a segmented pre-compensation component 830 as described with reference to FIG. 8.

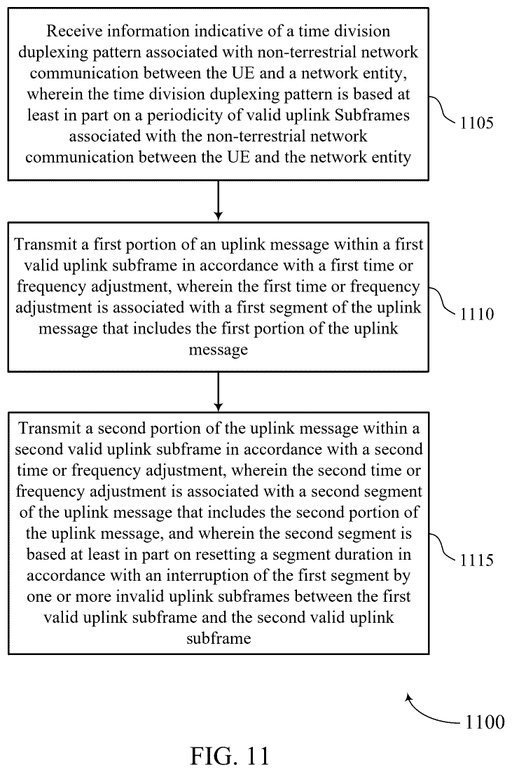

FIG. 11 shows a flowchart illustrating a method 1100 that supports segmented pre-compensation schemes for time division duplexing in a non-terrestrial network in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include receiving information indicative of a time division duplexing pattern associated with non-terrestrial network communication between the UE and a network entity, wherein the time division duplexing pattern is based at least in part on a periodicity of valid uplink subframes associated with the non-terrestrial network communication between the UE and the network entity. The operations of 1105 may be performed in accordance with examples as disclosed herein. In some examples, aspects of the operations of 1105 may be performed by a TDD component 825 as described with reference to FIG. 8.

At 1110, the method may include transmitting a first portion of an uplink message within a first valid uplink subframe in accordance with a first time or frequency adjustment, wherein the first time or frequency adjustment is associated with a first segment of the uplink message that includes the first portion of the uplink message. The operations of 1110 may be performed in accordance with examples as disclosed herein. In some examples, aspects of the operations of 1110 may be performed by a segmented pre-compensation component 830 as described with reference to FIG. 8.

At 1115, the method may include transmitting a second portion of the uplink message within a second valid uplink subframe in accordance with a second time or frequency adjustment, wherein the second time or frequency adjustment is associated with a second segment of the uplink message that includes the second portion of the uplink message, and wherein the second segment is based at least in part on resetting a segment duration in accordance with an interruption of the first segment by one or more invalid uplink subframes between the first valid uplink subframe and the second valid uplink subframe. The operations of 1115 may be performed in accordance with examples as disclosed herein. In some examples, aspects of the operations of 1115 may be performed by a segmented pre-compensation component 830 as described with reference to FIG. 8.

The following provides an overview of aspects of the present disclosure:

Aspect 1: A method for wireless communication at a UE, comprising: receiving information indicative of a time division duplexing pattern associated with non-terrestrial network communication between the UE and a network entity, wherein the time division duplexing pattern is based at least in part on a periodicity of valid uplink subframes associated with the non-terrestrial network communication between the UE and the network entity; and transmitting, within one or more valid uplink subframes in accordance with the periodicity of the valid uplink subframes, an uplink message in accordance with a segmented pre-compensation scheme that is based at least in part on the time division duplexing pattern.

Aspect 2: The method of aspect 1, wherein the segmented pre-compensation scheme is associated with a segment duration according to which the UE segments the uplink message in time and performs a respective time or frequency adjustment prior to each segment of the uplink message; and wherein the segmented pre-compensation scheme defines that the segment duration is reset in a next valid uplink subframe in accordance with an interruption, by an invalid uplink subframe associated with the time division duplexing pattern, of a segment within a prior valid uplink subframe.

Aspect 3: The method of aspect 2, wherein transmitting the uplink message in accordance with the segmented pre-compensation scheme comprises: transmitting a first portion of the uplink message within a first valid uplink subframe in accordance with a first time or frequency adjustment, wherein the first time or frequency adjustment is associated with a first segment of the uplink message that comprises the first portion of the uplink message; and transmitting a second portion of the uplink message within a second valid uplink subframe in accordance with a second time or frequency adjustment, wherein the second time or frequency adjustment is associated with a second segment of the uplink message that comprises the second portion of the uplink message, and wherein the second segment is based at least in part on resetting the segment duration in accordance with an interruption of the first segment by one or more invalid uplink subframes between the first valid uplink subframe and the second valid uplink subframe.

Aspect 4: The method of aspect 3, further comprising: performing the first time or frequency adjustment at a beginning of the first segment of the uplink message in accordance with starting the segment duration, wherein a duration of the first segment is defined by the segment duration; resetting the segment duration at a beginning of the second valid uplink subframe in accordance with the interruption of the first segment by the one or more invalid uplink subframes between the first valid uplink subframe and the second valid uplink subframe; and performing the second time or frequency adjustment at or prior to a beginning of the second segment of the uplink message in accordance with resetting the segment duration.

Aspect 5: The method of aspect 4, further comprising: transmitting or receiving an indication of a time gap within which the UE is capable of performing a time or frequency adjustment associated with the segmented pre-compensation scheme, wherein the UE performs the first time or frequency adjustment and the second time or frequency adjustment within respective durations of time defined by the time gap, and wherein, for the first time or frequency adjustment, the UE counts the time gap as being within the first segment of the uplink message and, for the second time or frequency adjustment, the UE counts the time gap as being within the one or more invalid uplink subframes between the first valid uplink subframe and the second valid uplink subframe.

Aspect 6: The method of aspect 5, wherein for the second time or frequency adjustment, the UE counts the time gap as being within the one or more invalid uplink subframes between the first valid uplink subframe and the second valid uplink subframe in accordance with a duration of the one or more invalid uplink subframes being greater than or equal to the time gap.

Aspect 7: The method of any of aspects 3-6, wherein the second segment of the uplink message has a same duration as other segments of the uplink message, and the same duration is defined by the segment duration.

Aspect 8: The method of any of aspects 3-6, wherein the second segment of the uplink message has a different duration than other segments of the uplink message, and a first duration of the other segments of the uplink message is defined by the segment duration and the different duration of the second segment of the uplink message is defined by a difference between the segment duration and a duration of the first segment of the uplink message within the first valid uplink subframe prior to the interruption.

Aspect 9: The method of any of aspects 3-8, wherein the uplink message comprises an PUSCH transmission, the first portion of the uplink message comprises a first portion of the PUSCH transmission, and the second portion of the uplink message comprises a second portion of the PUSCH transmission.

Aspect 10: The method of any of aspects 3-8, wherein the uplink message comprises a physical random access channel (PRACH) transmission that comprises a preamble repetition unit, the preamble repetition unit is associated with a plurality of symbol groups, the first portion of the uplink message comprises a first one or more symbol groups of the plurality of symbol groups, and the second portion of the uplink message comprises a second one or more symbol groups of the plurality of symbol groups.

Aspect 11: The method of any of aspects 1-10, wherein the segmented pre-compensation scheme is based at least in part on the time division duplexing pattern in accordance with the periodicity of the valid uplink subframes satisfying a threshold periodicity.

Aspect 12: The method of any of aspects 1-11, wherein the time division duplexing pattern comprises a plurality of non-consecutive sets of valid uplink subframes and a plurality of invalid uplink subframes, and a quantity of invalid uplink subframes after each set of valid uplink subframe of the plurality of non-consecutive sets of valid uplink subframes is based at least in part on the periodicity of the valid uplink subframes.

Aspect 13: The method of aspect 12, wherein each set of valid uplink subframes of the plurality of non-consecutive sets of valid uplink subframes comprises one or more valid uplink subframes.

Aspect 14: A UE for wireless communication, comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the UE to perform a method of any of aspects 1-13.

Aspect 15: A UE for wireless communication, comprising at least one means for performing a method of any of aspects 1-13.

Aspect 16: A non-transitory computer-readable medium storing code for wireless communication, the code comprising instructions executable by one or more processors (e.g., directly, indirectly, after pre-processing, without pre-processing) to perform a method of any of aspects 1-13.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive information indicative of a time division duplexing pattern associated with non-terrestrial network communication between the UE and a network entity, wherein the time division duplexing pattern is based at least in part on a periodicity of valid uplink subframes associated with the non-terrestrial network communication between the UE and the network entity; and
transmit, within one or more valid uplink subframes in accordance with the periodicity of the valid uplink subframes, an uplink message in accordance with a segmented pre-compensation scheme that is based at least in part on the time division duplexing pattern, wherein, to transmit the uplink message in accordance with the segmented pre-compensation scheme, the one or more processors are individually or collectively operable to execute the code to cause the UE to:
transmit a first portion of the uplink message within a first valid uplink subframe in accordance with a first time or frequency adjustment, wherein the first time or frequency adjustment is associated with a first segment of the uplink message that comprises the first portion of the uplink message; and
transmit a second portion of the uplink message within a second valid uplink subframe in accordance with a second time or frequency adjustment, wherein the second time or frequency adjustment is associated with a second segment of the uplink message that comprises the second portion of the uplink message, and wherein the second segment is based at least in part on resetting a segment duration in accordance with an interruption of the first segment by one or more invalid uplink subframes between the first valid uplink subframe and the second valid uplink subframe.

2. The UE of claim 1, wherein the segmented pre-compensation scheme:
is associated with the segment duration according to which the UE segments the uplink message in time and performs a respective time or frequency adjustment prior to each segment of the uplink message; and
defines that the segment duration is reset in a next valid uplink subframe in accordance with an interruption, by an invalid uplink subframe associated with the time division duplexing pattern, of a segment within a prior valid uplink subframe.

3. The UE of claim 1, wherein the one or more processors are individually or collectively further operable to execute the code to cause the UE to:
perform the first time or frequency adjustment at a beginning of the first segment of the uplink message in accordance with starting the segment duration, wherein a duration of the first segment is defined by the segment duration;
reset the segment duration at a beginning of the second valid uplink subframe in accordance with the interruption of the first segment by the one or more invalid uplink subframes between the first valid uplink subframe and the second valid uplink subframe; and
perform the second time or frequency adjustment at or prior to a beginning of the second segment of the uplink message in accordance with resetting the segment duration.

4. The UE of claim 1, wherein the UE performs the first time or frequency adjustment and the second time or frequency adjustment within respective durations of time defined by a time gap, and wherein:
for the first time or frequency adjustment, the UE counts the time gap as being within the first segment of the uplink message, and
for the second time or frequency adjustment, the UE counts the time gap as being within the one or more invalid uplink subframes between the first valid uplink subframe and the second valid uplink subframe.

5. The UE of claim 3, wherein the one or more processors are individually or collectively further operable to execute the code to cause the UE to:
transmit or receive an indication of a time gap within which the UE is capable of performing a time or frequency adjustment associated with the segmented pre-compensation scheme.

6. The UE of claim 4, wherein for the second time or frequency adjustment, the UE counts the time gap as being within the one or more invalid uplink subframes between the first valid uplink subframe and the second valid uplink subframe in accordance with a duration of the one or more invalid uplink subframes being greater than or equal to the time gap.

7. The UE of claim 1, wherein the second segment of the uplink message has a same duration as other segments of the uplink message, and wherein the same duration is defined by the segment duration.

8. The UE of claim 1, wherein the second segment of the uplink message has a different duration than other segments of the uplink message, and wherein:
a first duration of the other segments of the uplink message is defined by the segment duration; and
the different duration of the second segment of the uplink message is defined by a difference between the segment duration and a duration of the first segment of the uplink message within the first valid uplink subframe prior to the interruption.

9. The UE of claim 1, wherein the uplink message comprises a physical uplink shared channel (PUSCH) transmission, wherein the first portion of the uplink message comprises a first portion of the PUSCH transmission, and wherein the second portion of the uplink message comprises a second portion of the PUSCH transmission.

10. The UE of claim 1, wherein the uplink message comprises a physical random access channel (PRACH) transmission that comprises a preamble repetition unit, wherein the preamble repetition unit is associated with a plurality of symbol groups, wherein the first portion of the uplink message comprises a first one or more symbol groups of the plurality of symbol groups, and wherein the second portion of the uplink message comprises a second one or more symbol groups of the plurality of symbol groups.

11. The UE of claim 1, wherein the segmented pre-compensation scheme is based at least in part on the time division duplexing pattern in accordance with the periodicity of the valid uplink subframes satisfying a threshold periodicity.

12. The UE of claim 1, wherein the time division duplexing pattern comprises a plurality of non-consecutive sets of valid uplink subframes and a plurality of invalid uplink subframes, and wherein a quantity of invalid uplink subframes after each set of valid uplink subframes of the plurality of non-consecutive sets of valid uplink subframes is based at least in part on the periodicity of the valid uplink subframes.

13. A method for wireless communication at a user equipment (UE), comprising:
receiving information indicative of a time division duplexing pattern associated with non-terrestrial network communication between the UE and a network entity, wherein the time division duplexing pattern is based at least in part on a periodicity of valid uplink subframes associated with the non-terrestrial network communication between the UE and the network entity; and
transmitting, within one or more valid uplink subframes in accordance with the periodicity of the valid uplink subframes, an uplink message in accordance with a segmented pre-compensation scheme that is based at least in part on the time division duplexing pattern, wherein transmitting the uplink message in accordance with the segmented pre-compensation scheme comprises:
transmitting a first portion of the uplink message within a first valid uplink subframe in accordance with a first time or frequency adjustment, wherein the first time or frequency adjustment is associated with a first segment of the uplink message that comprises the first portion of the uplink message; and
transmitting a second portion of the uplink message within a second valid uplink subframe in accordance with a second time or frequency adjustment, wherein the second time or frequency adjustment is associated with a second segment of the uplink message that comprises the second portion of the uplink message, and wherein the second segment is based at least in part on resetting a segment duration in accordance with an interruption of the first segment by one or more invalid uplink subframes between the first valid uplink subframe and the second valid uplink subframe.

14. The method of claim 13, wherein the segmented pre-compensation scheme:
is associated with the segment duration according to which the UE segments the uplink message in time and performs a respective time or frequency adjustment prior to each segment of the uplink message; and
defines that the segment duration is reset in a next valid uplink subframe in accordance with an interruption, by an invalid uplink subframe associated with the time division duplexing pattern, of a segment within a prior valid uplink subframe.

15. The method of claim 13, further comprising:
performing the first time or frequency adjustment at a beginning of the first segment of the uplink message in accordance with starting the segment duration, wherein a duration of the first segment is defined by the segment duration;
resetting the segment duration at a beginning of the second valid uplink subframe in accordance with the interruption of the first segment by the one or more invalid uplink subframes between the first valid uplink subframe and the second valid uplink subframe; and
performing the second time or frequency adjustment at or prior to a beginning of the second segment of the uplink message in accordance with resetting the segment duration.

16. The method of claim 13,
wherein the UE performs the first time or frequency adjustment and the second time or frequency adjustment within respective durations of time defined by a time gap, and wherein:
for the first time or frequency adjustment, the UE counts the time gap as being within the first segment of the uplink message, and
for the second time or frequency adjustment, the UE counts the time gap as being within the one or more invalid uplink subframes between the first valid uplink subframe and the second valid uplink subframe.

17. The method of claim 15, further comprising:
transmitting or receiving an indication of a time gap within which the UE is capable of performing a time or frequency adjustment associated with the segmented pre-compensation scheme.

18. The method of claim 16, wherein for the second time or frequency adjustment, the UE counts the time gap as being within the one or more invalid uplink subframes between the first valid uplink subframe and the second valid uplink subframe in accordance with a duration of the one or more invalid uplink subframes being greater than or equal to the time gap.

19. The method of claim 13, wherein the second segment of the uplink message has a same duration as other segments of the uplink message, and wherein the same duration is defined by the segment duration.

20. The method of claim 13, wherein the second segment of the uplink message has a different duration than other segments of the uplink message, and wherein:
a first duration of the other segments of the uplink message is defined by the segment duration; and
the different duration of the second segment of the uplink message is defined by a difference between the segment duration and a duration of the first segment of the uplink message within the first valid uplink subframe prior to the interruption.

21. The method of claim 13, wherein the uplink message comprises a physical uplink shared channel (PUSCH) transmission, wherein the first portion of the uplink message comprises a first portion of the PUSCH transmission, and wherein the second portion of the uplink message comprises a second portion of the PUSCH transmission.

22. The method of claim 13, wherein the uplink message comprises a physical random access channel (PRACH) transmission that comprises a preamble repetition unit, wherein the preamble repetition unit is associated with a plurality of symbol groups, wherein the first portion of the uplink message comprises a first one or more symbol groups of the plurality of symbol groups, and wherein the second portion of the uplink message comprises a second one or more symbol groups of the plurality of symbol groups.

23. The method of claim 13, wherein the segmented pre-compensation scheme is based at least in part on the time division duplexing pattern in accordance with the periodicity of the valid uplink subframes satisfying a threshold periodicity.

24. The method of claim 13, wherein the time division duplexing pattern comprises a plurality of non-consecutive sets of valid uplink subframes and a plurality of invalid uplink subframes, and wherein a quantity of invalid uplink subframes after each set of valid uplink subframes of the plurality of non-consecutive sets of valid uplink subframes is based at least in part on the periodicity of the valid uplink subframes.

25. A user equipment (UE) for wireless communication, comprising:
means for receiving information indicative of a time division duplexing pattern associated with non-terrestrial network communication between the UE and a network entity, wherein the time division duplexing pattern is based at least in part on a periodicity of valid uplink subframes associated with the non-terrestrial network communication between the UE and the network entity; and
means for transmitting, within one or more valid uplink subframes in accordance with the periodicity of the valid uplink subframes, an uplink message in accordance with a segmented pre-compensation scheme that is based at least in part on the time division duplexing pattern, wherein the means for transmitting the uplink message in accordance with the segmented pre-compensation scheme comprises:
means for transmitting a first portion of the uplink message within a first valid uplink subframe in accordance with a first time or frequency adjustment, wherein the first time or frequency adjustment is associated with a first segment of the uplink message that comprises the first portion of the uplink message; and
means for transmitting a second portion of the uplink message within a second valid uplink subframe in accordance with a second time or frequency adjustment, wherein the second time or frequency adjustment is associated with a second segment of the uplink message that comprises the second portion of the uplink message, and wherein the second segment is based at least in part on resetting a segment duration in accordance with an interruption of the first segment by one or more invalid uplink subframes between the first valid uplink subframe and the second valid uplink subframe.

26. The UE of claim 25, wherein the segmented pre-compensation scheme:
is associated with the segment duration according to which the UE segments the uplink message in time and performs a respective time or frequency adjustment prior to each segment of the uplink message; and
defines that the segment duration is reset in a next valid uplink subframe in accordance with an interruption, by an invalid uplink subframe associated with the time division duplexing pattern, of a segment within a prior valid uplink subframe.

27. The UE of claim 25, further comprising:
means for performing the first time or frequency adjustment at a beginning of the first segment of the uplink message in accordance with starting the segment duration, wherein a duration of the first segment is defined by the segment duration;
means for resetting the segment duration at a beginning of the second valid uplink subframe in accordance with the interruption of the first segment by the one or more invalid uplink subframes between the first valid uplink subframe and the second valid uplink subframe; and
means for performing the second time or frequency adjustment at or prior to a beginning of the second segment of the uplink message in accordance with resetting the segment duration.

28. A non-transitory computer-readable medium storing code for wireless communication, the code comprising instructions executable by one or more processors to:
receive information indicative of a time division duplexing pattern associated with non-terrestrial network communication between a UE and a network entity, wherein the time division duplexing pattern is based at least in part on a periodicity of valid uplink subframes associated with the non-terrestrial network communication between the UE and the network entity; and
transmit, within one or more valid uplink subframes in accordance with the periodicity of the valid uplink subframes, an uplink message in accordance with a segmented pre-compensation scheme that is based at least in part on the time division duplexing pattern, wherein, to transmit the uplink message in accordance with the segmented pre-compensation scheme, the code further comprises instructions executable by the one or more processors to:
transmit a first portion of the uplink message within a first valid uplink subframe in accordance with a first time or frequency adjustment, wherein the first time or frequency adjustment is associated with a first segment of the uplink message that comprises the first portion of the uplink message; and
transmit a second portion of the uplink message within a second valid uplink subframe in accordance with a second time or frequency adjustment, wherein the second time or frequency adjustment is associated with a second segment of the uplink message that comprises the second portion of the uplink message, and wherein the second segment is based at least in part on resetting a segment duration in accordance with an interruption of the first segment by one or more invalid uplink subframes between the first valid uplink subframe and the second valid uplink subframe.

29. The non-transitory computer-readable medium of claim 28, wherein the segmented pre-compensation scheme:
is associated with the segment duration according to which the UE segments the uplink message in time and performs a respective time or frequency adjustment prior to each segment of the uplink message; and
defines that the segment duration is reset in a next valid uplink subframe in accordance with an interruption, by an invalid uplink subframe associated with the time division duplexing pattern, of a segment within a prior valid uplink subframe.

30. The non-transitory computer-readable medium of claim 28, the code comprising further instructions executable by the one or more processors to:
perform the first time or frequency adjustment at a beginning of the first segment of the uplink message in accordance with starting the segment duration, wherein a duration of the first segment is defined by the segment duration;
reset the segment duration at a beginning of the second valid uplink subframe in accordance with the interruption of the first segment by the one or more invalid uplink subframes between the first valid uplink subframe and the second valid uplink subframe; and
perform the second time or frequency adjustment at or prior to a beginning of the second segment of the uplink message in accordance with resetting the segment duration.
